(19) United States
(12) Patent Application Publication
(10) Pub. No.: US 2026/0241281 A1
(43) Pub. Date: Aug. 20, 2026

(54) RECORDING MEDIUM STORING INFORMATION PROCESSING PROGRAM, INFORMATION PROCESSING METHOD AND INFORMATION PROCESSING DEVICE

(71) Applicant: KOEI TECMO GAMES CO., LTD., Yokohama-shi (JP)

(72) Inventor: Keijiro MASHIKO, Kanagawa (JP)

(21) Appl. No.: 19/455,836

(22) Filed: Jan. 22, 2026

(30) Foreign Application Priority Data
Feb. 19, 2025 (JP) 2025-025458

(51) Int. Cl. A63F 13/53; A63F 13/5258; A63F 13/56

(52) U.S. Cl. CPC A63F 13/53; A63F 13/5258; A63F 13/56

(57) ABSTRACT

A non-transitory recording medium storing an information processing program executable by a computer to perform, in a game in which, in a virtual space, a player object that is a game object manipulated by a player carries out an attack on a first object among a plurality of game objects that can be targets of an attack by the player object, processing of, in a case in which the player object carries out an attack on the first object in a state in which a condition, which is set as a condition for reproducing a motion that the player cannot manipulate the player object to perform, is satisfied, setting a reproduction time of a motion of the first object according to a number of second objects that exist within a predetermined range at a periphery of the player object and that are other than the first object.

### CROSS-REFERENCE TO RELATED APPLICATION

This application is based on and claims priority under 35 USC 119 from Japanese Patent Application No. 2025-025458, filed on Feb. 19, 2025, the disclosure of which is incorporated by reference herein.

### BACKGROUND

### Technical Field

The present disclosure relates to a recording medium storing an information processing program, an information processing method and an information processing device.

### Related Art

Japanese Patent Application Laid-Open (JP-A) No. 2019-063628 discloses a game in which a player character, which the player manipulates, and enemy characters engage in combat. In this game, plural enemy characters exist in a virtual space in the game.

### SUMMARY

By the way, games are known in which a player object, which is a game object that the player manipulates, attacks an enemy object that is a game object that is the target of the attack. In such a game, there are cases in which, if the player object carries out an attack under a specific condition, the motions of the player object and the enemy object are reproduced in a state in which it is not possible for the player to manipulate the player object. In this case, it may not be possible for the combat in the game to be carried out smoothly.

An object of the present disclosure is to provide an information processing program, an information processing method and an information processing device by which combat in a game can be carried out smoothly.

An information processing program of a first aspect causes a computer to execute, in a game in which, in a virtual space, a player object that is a game object manipulated by a player carries out an attack on a first object among a plurality of game objects that can be targets of an attack by the player object, a processing of, in a case in which the player object carries out an attack on the first object in a state in which a condition, which is set as a condition for reproducing a motion that the player cannot manipulate the player object to perform, is satisfied, setting a reproduction time of a motion of the first object according to a number of second objects that exist within a predetermined range at a periphery of the player object and that are other than the first object.

In an information processing program of a second aspect, in the information processing program of the first aspect, the motions include a first motion and a second motion having a reproduction time that is shorter than a reproduction time of the first motion, and the information processing program is executable to cause the computer to perform processing of: reproducing the first motion in a case in which the number of the second objects existing within the predetermined range is zero, and reproducing the second motion in a case in which the number of the second objects existing within the predetermined range is one or more.

In an information processing program of a third aspect, the information processing program of the first aspect or the second aspect causes the computer to execute a processing of, determining a moving range of a virtual camera corresponding to a viewpoint of the player during reproduction of the motion according to the number of the second objects existing within the predetermined range.

In an information processing program of a fourth aspect, the information processing program of any one of the first aspect through the third aspect causes the computer to execute processings of: storing information indicating an imaging range of a virtual camera corresponding to a viewpoint of the player at a point in time when the player object started an attack on the first object in a state in which the condition was satisfied; and after finishing reproduction of the motion, returning the imaging range of the virtual camera to an imaging range that was stored.

An information processing method of a fifth aspect causes a computer to execute, in a game in which, in a virtual space, a player object that is a game object manipulated by a player carries out an attack on a first object among a plurality of game objects that can be targets of an attack by the player object, processing of, in a case in which the player object carries out an attack on the first object in a state in which a condition, which is set as a condition for reproducing a motion that the player cannot manipulate the player object to perform, is satisfied, setting a reproduction time of a motion of the first object according to a number of second objects that exist within a predetermined range at a periphery of the player object and that are other than the first object.

An information processing device of a sixth aspect has a processor, wherein, in a game in which, in a virtual space, a player object that is a game object manipulated by a player carries out an attack on a first object among a plurality of game objects that can be targets of an attack by the player object, in a case in which the player object carries out an attack on the first object in a state in which a condition, which is set as a condition for reproducing a motion that the player cannot manipulate the player object to perform, is satisfied, the processor sets a reproduction time of a motion of the first object according to a number of second objects that exist within a predetermined range at a periphery of the player object and that are other than the first object.

In accordance with the present disclosure, combat in a game can be carried out smoothly.

### BRIEF DESCRIPTION OF THE DRAWINGS

FIG. 1 is a block drawing illustrating an example of hardware structures of an information processing device;

FIG. 2 is a block drawing illustrating an example of functional structures of the information processing device;

FIG. 3 is a drawing for explaining a situation in which a second motion is reproduced;

FIG. 4 is a drawing for explaining a situation in which a first motion is reproduced;

FIG. 5 is a plan view for explaining ranges of movement of a virtual camera; and

FIG. 6 is a flowchart illustrating an example of motion reproducing processing.

### DETAILED DESCRIPTION

Examples of forms for implementing the technique of the present disclosure are described in detail hereinafter with reference to the drawings.

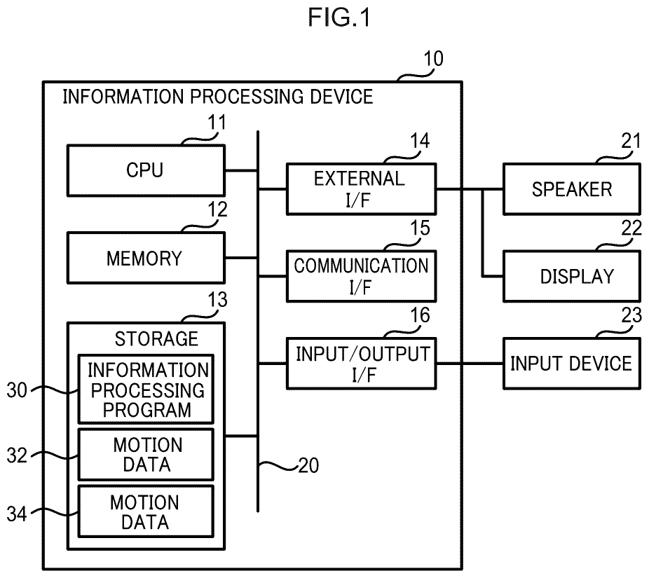

First, hardware structures of an information processing device 10 relating to a present embodiment are described with reference to FIG. 1. The information processing device 10 is, for example, a home gaming device, a portable gaming device, a commercial gaming device, a smartphone, a table terminal or a personal computer. In the present embodiment, as an example, description is given of an example in which a home gaming device is used as the information processing device 10. The information processing device 10 is an example of the computer.

As illustrated in FIG. 1, the information processing device 10 has a CPU (Central Processing Unit) 11, a memory 12, a storage 13, an external I/F (InterFace) 14, a communication I/F 15 and an input/output I/F 16. The CPU 11, the memory 12, the storage 13, the external I/F 14, the communication I/F 15 and the input/output I/F 16 are respectively connected via bus 20 so as to be able to communicate with one another.

The CPU 11 is a central computing processing unit, and executes various programs and controls respective sections. The CPU 11 is an example of the processor. The memory 12 temporarily stores programs and data as a workspace. The storage 13 is structured by a storage device such as an HDD (Hard Disk Drive), an SSD (Solid State Drive) or a flash memory, and stores various programs and various data.

An information processing program 30 for executing a predetermined game at the information processing device 10 is stored in the storage 13. The CPU 11 reads-out the information processing program 30 from the storage 13, and executes the information processing program 30 by using the memory 12 as a workspace. Note that the information processing program 30 is not limited to a form of being stored in the storage 13, and may be stored on a recording medium such as an optical disk, a USB (Universal Serial Bus) memory, or an SD memory card. Further, the information processing program 30 may be made to be downloadable to the information processing device 10 via the communication I/F 15. Moreover, the information processing program 30 can be provided as a program product. Program products include products of all forms for providing programs. For example, program products include programs that are provided over a network such as the internet, and computer-readable, non-transitory recording media such as optical disks on which a program is stored.

The external I/F 14 is an interface for connecting the information processing device 10 to various external devices. In the present embodiment, a speaker 21 and a display 22 are connected to the external I/F 14.

The speaker 21 outputs various sounds. The speaker 21 may be integral with the information processing device 10, or may be integral with the display 22. The display 22 is, for example, a liquid crystal display or an organic EL (Electro Luminescence) display, and displays various information. The display 22 may have a touch panel that is integral therewith. Further, the display 22 may be integral with the information processing device 10.

The communication I/F 15 is an interface for connecting the information processing device 10 to a network. For example, wired communication standards such as Ethernet™ and FDDI (Fiber Distributed Data Interface), or wireless communication standards such as 4G, 5G and Wi-Fi™, are used at the communication I/F 15.

The input/output I/F 16 is an interface for connecting an input device 23 to the information processing device 10. The input device 23 is a game controller having operation buttons and direction keys, or a mouse, a keyboard or the like, and is used for carrying out various types of input. The user carries out the operations of the game by using the input device 23. Operation information expressing the contents of input operations, which the user carries out by using the input device 23, are stored in the memory 12. The input device 23 may be integral with the information processing device 10. Further, the input device 23 may be detachable with respect to the information processing device 10. The number of the input devices 23 may be one or may be plural. Further, the input device 23 may be a touch panel that is integral with the display 22.

The information processing device 10 relating to the present embodiment provides a game in which a character, which is manipulated by the player who is the user of the information processing device 10 (hereinafter called “player character”), battles enemy characters. The player character is an example of the player object that is a game object that the player manipulates, and the enemy characters are examples of game objects that are enemies of the player character. Further, the enemy characters are examples of game objects that the player character can make be the target of an attack. In a case in which a game object, which the player character can make be the target of an attack, exists within the attack range of the attacking means (e.g., a part of the body or a weapon) of the player character, that game object is a game object that the player character can set as the target of the attack. A game object that can be made to be the target of an attack is not limited to an enemy character, and may be an object such as an animal, a building, a natural object or a structure. The game object is an object that appears in the game such as a character, a tool or a gimmick. A character is a being such as a person, an animal, a robot, a machine, or a fictitious being that appears in the game, and the type thereof is not particularly limited. The game is the collection of activities and rules for carrying out a game for entertainment or a competition. The game is played by, for example, players effectively utilizing strategies and techniques for achieving specific goals. For example, the game is played for any of various purposes such as for competitive purposes such as winning, for the purpose of battling such as felling enemies, for educational purposes such as learning, and for purposes of narration such as concluding the progression of a scenario. The game may be a competitive-type game or may be a non-competitive type game.

In the present embodiment, description is given of an example in which the enemy characters are NPCs (Non Player Characters). Further, in the game provided by the information processing device 10, plural enemy characters exist within a virtual space such as the stage of the game.

Motion data 32 and motion data 34 are stored in the storage 13. The motion data 32 and the motion data 34 are data that include motions of the player character and an enemy character that are reproduced in a case in which the player character carries out an attack on the enemy character in a state in which a condition described hereinafter is satisfied. The motion data 32 and the motion data 34 are structured to include plural frames (i.e., plural still images that are continuous).

For example, in a case in which the player character attacks an enemy character with a sword, the motion of the player character is a moving image expressing the action of slashing the enemy character with the sword. In this case, the motion of the enemy character is a moving image expressing the action of being slashed by the sword. The motions included in the motion data 32 and the motion data 34 are reproduced as a production of a case in which the player character attacks an enemy character under a specific condition.

The motion data 32 includes first motions. The motion data 34 includes second motions whose reproduction times are shorter than those of the first motions. In the present embodiment, the reproduction time of a second motion is shorter than the reproduction time of a first motion due to the number of frames of the second motion being smaller than the number of frames of the first motion. For example, a first motion is a moving image of approximately six seconds, and a second motion is a moving image of approximately three seconds. A first motion is, for example, a motion whose purpose is to end combat by making the rendered colors intense. Further, for example, a first motion is a motion whose purpose is to heighten the feel of immersion in the combat by making the rendered colors intense, or a motion whose purpose is to render elation in the climax of the combat. A second motion is, for example, a motion whose purpose is to not stop the flow of the combat and not interrupt the player's concentration. Note that first motions and second motions may include sounds such as dialogue or the like.

In the game relating to the present embodiment, during reproduction of a first motion and during reproduction of a second motion, there is a state in which the player cannot manipulate the player character. Similarly, during reproduction of a first motion and during reproduction of a second motion, the enemy character as well cannot take actions other than a motion such as movement.

In the game relating to the present embodiment, a parameter that is called energy is set for the player character and the enemy character. Energy is a parameter corresponding to stamina, and is a parameter affecting the number of times of attack by a character. For example, in a case in which the player character attacks an enemy character, the energy of the player character decreases by an amount corresponding to the carrying out of the attack, and the energy of the enemy character decreases by an amount corresponding to the receiving of the attack. Further, energy can be restored gradually (so-called natural restoration) over the passage of time.

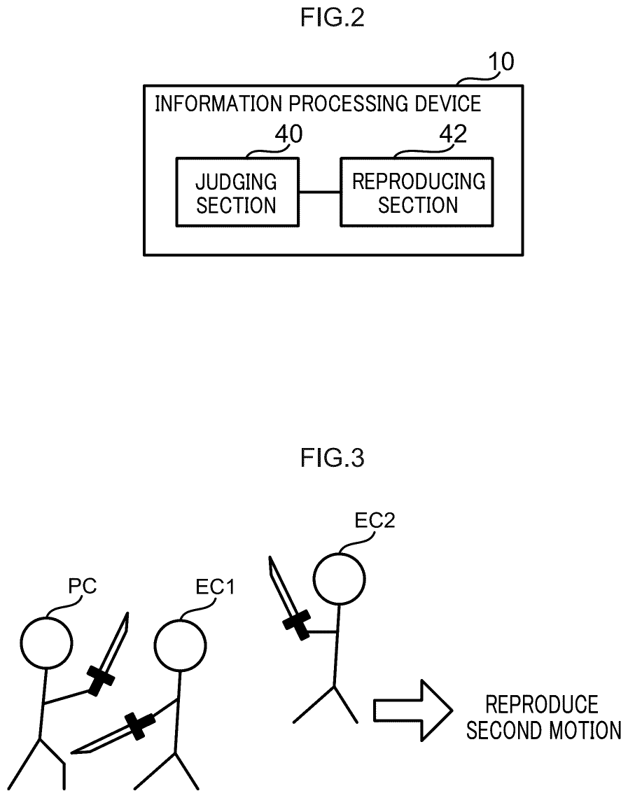

Functional structures of the information processing device 10 are described next with reference to FIG. 2. As illustrated in FIG. 2, the information processing device 10 includes a judging section 40 and a reproducing section 42. The CPU 11 functions as the judging section 40 and the reproducing section 42 by executing the information processing program 30.

The judging section 40 judges whether or not the player character has carried out an attack on an enemy character in a state in which a condition (hereinafter called “motion reproduction condition”), which has been set as a condition for reproducing a motion that the player cannot manipulate the player character to perform, is satisfied. An example of a motion reproduction condition is the condition that there is a state in which the energy of the enemy character is a threshold value (e.g., 0) or less. Further examples of motion reproduction conditions are conditions that there is a state in which the player character is not aware of an enemy character, or a state in which the enemy character has lost sight of the player character. Another example of a motion reproduction condition is the condition that there is a state in which, when an attack by the player character is carried out, the strength of the enemy character becomes a threshold value (e.g., 0) or less. Further, an example of a motion reproduction condition is the condition that there is a state in which the player has inputted an operation for a special attack, such as a finishing move, that is different than usual attacks. In the following description, the enemy character that is the target of the attack by the player character is called the “first enemy character”, and enemy characters existing the virtual space who are other than the first enemy character, i.e., enemy characters that are not targets of the attack by the player character, are called “second enemy characters”.

In a case in which the judging section 40 judges that the player character has carried out an attack on the first enemy character in a state in which a motion reproduction condition is satisfied, the reproducing section 42 reproduces, as the motions of the player character and the first enemy character, motions that are such that, the greater the number of second enemy characters existing within a predetermined range at the periphery of the player character, the shorter the reproduction times of the motions. For example, in this manner, the reproducing section 42 sets a reproduction time of a motion of a first object according to a number of second objects that exist within the predetermined range at the periphery of a player object and that are other than the first object. An example of the predetermined range at the periphery of the player character is a range inside a circle whose center is the player character and that has a predetermined radius. The radius in this case is set to, for example, a length corresponding to a distance of 10 m in the virtual space. Another example of the aforementioned predetermined range is the range in a predetermined area that defines the stage. Further, an example of the predetermined range is a range in which attacks by the player character are possible. Moreover, an example of the predetermined range is a range calculated from the distance over which enemy characters within the stage can be aware of the player character.

Specifically, as illustrated in FIG. 3, the reproducing section 42 reproduces a second motion that is included in the motion data 34 in a case in which player character PC attacks a first enemy character EC1 whose energy is a threshold value or less, and the number of second enemy characters EC2 existing within the predetermined range is one or more.

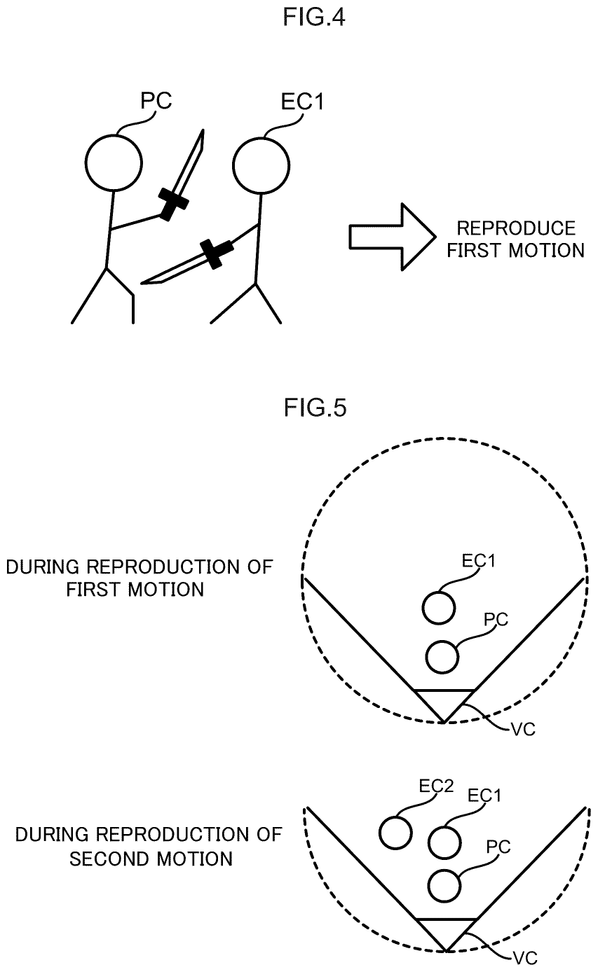

Further, as illustrated in FIG. 4, the reproducing section 42 reproduces a first motion that is included in the motion data 32 in a case in which the player character PC attacks the first enemy character EC1 whose energy is a threshold value or less, and the number of second enemy characters EC2 existing within the predetermined range is zero.

The reproducing section 42 stores, in the memory 12, information expressing the imaging range of a virtual camera corresponding to the viewpoint of the player at the point in time when the player character started the attack on the first enemy object in the state in which the motion reproduction condition was satisfied. Examples of information expressing the imaging range of a virtual camera are the position of the virtual camera within the virtual space and the angle showing the imaging range of the virtual camera. Then, after finishing reproducing the first motion or the second motion, the reproducing section 42 returns the imaging range of the virtual camera to the imaging range that was stored. Due thereto, after reproduction of the motion is finished, the player can smoothly start manipulating the player character.

Further, as illustrated in FIG. 5, the greater the number of second enemy characters EC2 existing in the predetermined range, the more that the reproducing section 42 narrows the range of movement of virtual camera VC that corresponds to the viewpoint of the player during reproduction of the motion. For example, in this manner, the reproducing section 42 determines a moving range of the virtual camera corresponding to the viewpoint of the player during reproduction of the motion according to the number of the second objects existing within the predetermined range In the example of FIG. 5, the moving range of the virtual camera VC during reproduction of a first motion, and the moving range of the virtual camera VC during reproduction of a second motion, are shown by the dashed lines. Further, in the example of FIG. 5, the region at the inner side of the left and right straight lines that extend from the virtual camera VC shows the image angle of the virtual camera VC. Moreover, the example of FIG. 5 shows that, during reproduction of a first motion, i.e., in a case in which the number of second enemy characters EC2 existing in the predetermined range is zero, the virtual camera VC that is positioned behind the player character PC can rotate within a 360° range. Still further, the example of FIG. 5 illustrates that, during reproduction of a second motion, i.e., in a case in which the number of second enemy characters EC2 existing within the predetermined range is one or more, the virtual camera VC that is positioned behind the player character PC can rotate within a 180° range. By making the moving range of the virtual camera VC narrower during reproduction of a second motion whose reproduction time is shorter than that of a first motion, the player, who is looking at the display 22 on which the second motion is being reproduced, becoming motion sick can be suppressed.

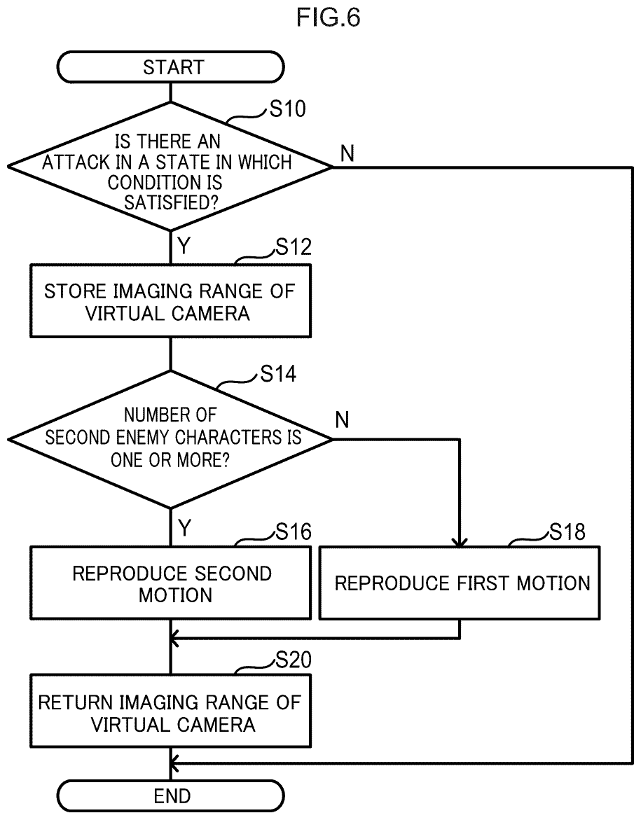

Operation of the information processing device 10 is described next with reference to FIG. 6. The motion reproducing processing illustrated in FIG. 6 is executed due to the CPU 11 executing the information processing program 30.

In step S10 of FIG. 6, the judging section 40 judges whether or not the player character has carried out an attack on the first enemy character in a state in which a motion reproduction condition is satisfied. If this judgment is negative, the motion reproducing processing ends. If this judgment is affirmative, processing moves on to step S12.

In step S12, the reproducing section 42 stores, in the memory 12, information expressing the imaging range of a virtual camera. In step S14, the reproducing section 42 judges whether or not the number of second enemy characters existing within a predetermined range at the periphery of the player character is one or more. If this judgment is affirmative, processing moves on to step S16. In step S16, the reproducing section 42 reproduces a second motion that is included in the motion data 34. When the processing of step S16 ends, processing moves on to step S20.

On the other hand, if the number of second enemy characters existing within the predetermined range at the periphery is zero, the judgment in step S14 is negative, and processing moves on to step S18. In step S18, the reproducing section 42 reproduces a first motion that is included in the motion data 32. When the processing of step S18 ends, processing moves on to step S20.

In step S20, the reproducing section 42 returns the imaging range of the virtual camera to the imaging range that was stored in step S12. When the processing of step S20 ends, the motion reproducing processing ends.

As described above, in accordance with the present embodiment, in a case in which the number of second enemy characters existing within a predetermined range at the periphery of the player character is one or more, a second motion that is shorter than a first motion is reproduced. Due thereto, as a result of being able to shorten the standby time until the player becomes able to manipulate the player character, the combat in the game can be carried out smoothly. Further, as a result, the amount of the energy of the second enemy character that is restored naturally can be decreased, and therefore, the player being at a disadvantage while the player cannot manipulate the player character can be suppressed.

Note that, although the above embodiment describes a case in which motions are reproduced by switching between two types of motions whose reproduction times differ, the technique of the present disclosure is not limited to such a form. There may be a form in which motions are reproduced by switching among three or more types of motions of differing reproduction times. Such forms as well exemplify cases in which, if the judging section 40 judges that the player character has attacked the first enemy character in a state in which a motion reproduction condition is satisfied, the reproducing section 42 reproduces, as motions of the player character and the first enemy character, motions whose reproduction times are shorter the greater the number of second enemy characters existing within a predetermined range at the periphery of the player character.

Further, the various processings that the CPU 11 executes by reading-in software (the program) in the above-described embodiment may be executed by any of various types of processors other than a CPU. Examples of processors in this case include PLDs (Programmable Logic Devices) whose circuit structure can be changed after production such as FPGAs (Field-Programmable Gate Arrays), and dedicated electrical circuits that are processors having circuit structures that are designed for the sole purpose of executing specific processings such as ASICs (Application Specific Integrated Circuits). Further, the various processings may be executed by one of these various types of processors, or may be executed by a combination of two or more of the same type or different types of processors (e.g., plural FPGAs, or a combination of a CPU and an FPGA). Further, the hardware structures of these various types of processors are, more specifically, electrical circuits that combine circuit elements such as semiconductor elements.

What is claimed is:

1. A non-transitory recording medium storing an information processing program executable by a computer to perform, in a game in which, in a virtual space, a player object that is a game object manipulated by a player carries out an attack on a first object among a plurality of game objects that can be targets of an attack by the player object, processing of:
in a case in which the player object carries out an attack on the first object in a state in which a condition, which is set as a condition for reproducing a motion that the player cannot manipulate the player object to perform, is satisfied, setting a reproduction time of a motion of the first object according to a number of second objects that exist within a predetermined range at a periphery of the player object and that are other than the first object.

2. The non-transitory recording medium storing the information processing program of claim 1, wherein:
the motions include a first motion and a second motion having a reproduction time that is shorter than a reproduction time of the first motion, and
the information processing program is executable to cause the computer to perform processing of:
reproducing the first motion in a case in which the number of the second objects existing within the predetermined range is zero, and
reproducing the second motion in a case in which the number of the second objects existing within the predetermined range is one or more.

3. The non-transitory recording medium storing the information processing program of claim 1, wherein the information processing program is executable to cause the computer to perform processing of, determining a moving range of a virtual camera corresponding to a viewpoint of the player during reproduction of the motion according to the number of the second objects existing within the predetermined range.

4. The non-transitory recording medium storing the information processing program of claim 1, wherein the information processing program is executable to cause the computer to perform processing of:
storing information indicating an imaging range of a virtual camera corresponding to a viewpoint of the player at a point in time when the player object started an attack on the first object in a state in which the condition was satisfied; and
after finishing reproduction of the motion, returning the imaging range of the virtual camera to an imaging range that was stored.

5. An information processing method executable by a computer to perform, in a game in which, in a virtual space, a player object that is a game object manipulated by a player carries out an attack on a first object among a plurality of game objects that can be targets of an attack by the player object, processing of:
in a case in which the player object carries out an attack on the first object in a state in which a condition, which is set as a condition for reproducing a motion that the player cannot manipulate the player object to perform, is satisfied, setting a reproduction time of a motion of the first object according to a number of second objects that exist within a predetermined range at a periphery of the player object and that are other than the first object.

6. An information processing device comprising a processor, wherein, in a game in which, in a virtual space, a player object that is a game object manipulated by a player carries out an attack on a first object among a plurality of game objects that can be targets of an attack by the player object,
in a case in which the player object carries out an attack on the first object in a state in which a condition, which is set as a condition for reproducing a motion that the player cannot manipulate the player object to perform, is satisfied, the processor sets a reproduction time of a motion of the first object according to a number of second objects that exist within a predetermined range at a periphery of the player object and that are other than the first object.
